(19) United States
(12) Patent Application Publication
(10) Pub. No.: US 2002/0106470 A1
(43) Pub. Date: Aug. 8, 2002

(54) Tube based on vulcanized elastomer and fluoropolymer

(75) Inventors: Joachim Merziger, Evreux (FR); Christophe Maldeme, Rambouillet (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/012,044

(22) Filed: Dec. 11, 2001

(30) Foreign Application Priority Data
Dec. 11, 2000 (FR) 0016067

(51) Int. Cl. B32B 1/08; F16L 11/00

(52) U.S. Cl. 428/36.91; 138/137; 138/141

(57) ABSTRACT

The present invention relates to a tube having in its radial direction, from the inside outwards:

1) a so-called inner layer intended to come into contact with a circulating fluid, the said inner layer comprising (i) a fluoropolymer, (ii) optionally an electrically conductive product and (iii) a triblock copolymer ABC, the three blocks A, B, and C being linked together in this order, each block being either a homopolymer or a copolymer obtained from two or more monomers, the block A being linked to the block B and the block B to the block C by means of a covalent bond or an intermediate molecule linked to one of these blocks via a covalent bond and to the other block via another covalent bond, and such that:

block A is compatible with the fluoropolymer,

block B is incompatible with the fluoropolymer and is incompatible with block A,

block C is incompatible with the fluoropolymer, block A and block B,

2) optionally, a binder layer,

3) a layer of vulcanized elastomer.

According to a second form of the invention the inner layer itself consists of two layers, one containing an electrically conductive product and the other containing no electrically conductive product. Advantageously, the layer which is in contact with the circulating fluid contains the electrically conductive product.

According to a third form of the invention a layer of fluoropolymer is provided between the inner layer and the binder layer or between the inner layer and the layer of vulcanized elastomer if there is no binder.

The second and third forms of the invention may exist simultaneously for the same tube.

### FIELD OF THE INVENTION

The present invention relates to tubes based on vulcanized elastomer and fluoropolymer, and more particularly tubes with an inner layer made of fluoropolymer and an outer layer made of vulcanized elastomer. These tubes are useful, for example, in motor vehicles to convey fuel from the tank to the injection system, for the air conditioning circuit, for the coolant fluid and for transferring the fluids of a fuel cell.

### THE TECHNICAL PROBLEM

Patent EP 683725 discloses tubes consisting successively of an inner layer made of PVDF (polyvinylidene fluoride), a co-extrusion binder and an outer layer made of vulcanized elastomer. They have the advantage of having good resistance to corrosive chemical fluids and of being a barrier to many fluids, in particular motor fuel and the fluids used in air conditioning circuits. However, they may be fragile at low temperature. It is known how to improve the impact strength of PVDF, but this is at the expense of its chemical resistance and its barrier properties.

It has now been found that by adding a triblock copolymer such as poly(styrene)-poly(butadiene)-poly(methyl methacrylate) to the fluoropolymer which constitutes the inner layer of a tube having an inner layer made of fluoropolymer and an outer layer made of vulcanized elastomer, a tube is obtained whose inner layer conserves the chemical resistance of the fluoropolymer, and this tube has very good impact strength.

Furthermore, it is occasionally necessary for the PVDF layer to be conductive. The friction of a solvent on the PVDF inner layer of a tube may generate electrostatic charges, an accumulation of which may lead to an electric discharge (spark) capable of igniting the solvent, with catastrophic consequences (explosion). Thus, it is necessary to make these components conductive.

It is also known practice to lower the surface resistivity of polymer materials or resins by incorporating therein conductive materials and/or semiconductors such as carbon black, steel fibers, carbon fibers, particles (fibers, plates or spheres) metallized with gold, silver or nickel. Among these materials, carbon black is more particularly used, for economic reasons and for its ease of use. Besides its specific electrical conductivity properties, carbon black behaves like a filler such as, for example, talc, chalk or kaolin. Thus, a person skilled in the art knows that when the filler content increases, the viscosity of the polymer/filler mixture increases. Similarly, when the filler content increases, the flexural modulus of the filler-containing polymer increases and its impact strength decreases. These known and predictable phenomena are discussed in detail in “Handbook of Fillers and Reinforcements for Plastics” edited by H. S. Katz and J. V. Milewski—Van Nostrand Reinhold Company—ISBN 0-442-25372-9, see in particular chapter 2, section II for fillers in general and chapter 16, section VI for carbon black in particular. As regards the electrical properties of carbon black, the technical report “Ketjenblack EC—BLACK 94/01” from the company Akzo Nobel indicates that the resistivity of the formulation falls very abruptly when a critical carbon black content, known as the percolation threshold, is reached. When the carbon black content increases further, the resistivity decreases rapidly until it reaches a stable level (plateau zone). For a given resin, it is thus preferred to work in the plateau zone, in which a metering error will have only a small effect on the resistivity of the compound.

PVDF has fragile multiaxial impact behaviour. The addition of an agent to make it electrically conductive, such as carbon black, makes it even more fragile. The various ways of improving the impact strength properties usually involve the incorporation of soft elastomeric phases which may have morphologies of “core-shell” types in a PVDF matrix. The major drawback of such a combination is the large decrease in its chemical resistance.

### SUMMARY OF THE INVENTION

It has now been found that by adding a triblock copolymer, e.g. poly(styrene)-poly(butadiene)-poly(methyl methacrylate) and an electrically conductive product to the fluoropolymer which constitutes the inner layer of a tube having an inner layer made of fluoropolymer and an outer layer made of vulcanized elastomer, a tube is obtained having an antistatic inner layer which conserves the chemical resistance of the fluoropolymer, and that this tube has very good impact strength.

The present invention relates to a tube having in its radial direction, from the inside outwards:

1) a so-called inner layer intended to come into contact with a circulating fluid, the said inner layer comprising (i) a fluoropolymer, (ii) optionally an electrically conductive product and (iii) a triblock copolymer ABC, the three blocks A, B, and C being linked together in this order, each block being either a homopolymer or a copolymer obtained from two or more monomers, the block A being linked to the block B and the block B to the block C by means of a covalent bond or an intermediate molecule linked to one of these blocks via a covalent bond and to the other block via another covalent bond, and such that:

block A is compatible with the fluoropolymer,

block B is incompatible with the fluoropolymer and is incompatible with block A,

block C is incompatible with the fluoropolymer, block A and block B,

2) optionally, a binder layer,

3) a layer of vulcanized elastomer.

According to a second form of the invention the inner layer itself consists of two layers, one containing an electrically conductive product and the other containing no electrically conductive product. Advantageously, the layer which is in contact with the circulating fluid contains the electrically conductive product.

According to a third form of the invention a layer of fluoropolymer is provided between the inner layer and the binder layer or between the inner layer and the layer of vulcanized elastomer if there is no binder.

The second and third forms of the invention may exist simultaneously for the same tube.

The tubes of the invention have many advantages:

they are impact-resistant under cold conditions (−40° C.),

they can be made antistatic,

they have very good resistance to chemical products and can thus convey corrosive fluids,

they are barriers to a great many fluids such as, for example, motor vehicle fuel and air conditioning fluids,

they are clean, i.e. the inner layer contains essentially no products which may migrate, such as oligomers or plasticizers, and there is thus no risk that the fluid circulating in the tube might entrain these products, which could block the devices placed on the circuit of this fluid. Specifically, the triblock copolymer ABC and the fluoropolymer constitute a stable blend of polymers, and the optional electrically conductive product becomes inserted in this blend and does not migrate.

These tubes may be manufactured by co-extrusion, each layer being introduced in molten form with the aid of an extruder, in a co-extrusion head which produces concentric flows forming the tube. This technique is known per se. The tube is then treated in a heating tunnel or oven to vulcanize (crosslink) the elastomer. It is recommended during the co-extrusion to use a co-extrusion head in which the flow of elastomer remains at a sufficiently low temperature (generally of about from 80° C. to 120° C.) so as not to cause vulcanization before the formation of the tube and above all block the extruder. A tube not comprising the layer of elastomer may also be manufactured by co-extrusion, and this tube may then subsequently be treated in a “coating” or “crosshead” device to coat the layer of elastomer. It then suffices, as above, to treat the tube in a heating tunnel or oven in order to vulcanize (crosslink) the elastomer.

As regards the fluoropolymer, any polymer is denoted which has in its chain at least one monomer chosen from compounds containing a vinyl group capable of opening to polymerize and which contains, directly attached to this vinyl group, at least one fluorine atom, a fluoroalkyl group or a fluoroalkoxy group.

Examples of monomers which may be mentioned include vinyl fluoride; vinylidene fluoride (VF2); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂=CFOCF₂CF(CF₃)OCF₂CF₂X in which X is SO₂F, CO₂H, CH₂OH, CH₂OCN or CH₂OPO₃H; the product of formula CF₂=CFOCF₂CF₂SO₂F; the product of formula F(CF₂)nCH₂OCF=CF₂ in which n is 1, 2, 3, 4 or 5; the product of formula R1CH₂OCF=CF₂ in which R1 is hydrogen or F(CF₂)z and z is 1, 2, 3 or 4; the product of formula R3OCF=CH₂ in which R3 is F(CF₂)z- and z is 1, 2, 3 or 4; perfluorobutylethylene (PFBE); 3,3,3-trifluoropropene and 2-trifluoromethyl-3, 3,3-trifluoro-1-propene.

The fluoropolymer may be a homopolymer or a copolymer, and may also comprise non-fluoro monomers such as ethylene.

The fluoropolymer is advantageously chosen from:

Vinylidene fluoride (VF2) homopolymers and copolymers preferably containing at least 50% by weight of VF2, the copolymer being chosen from chlorotrifluoroethylene (CTFE), hexafluoropropylene (HFP), trifluoroethylene (VF3) and tetrafluoroethylene (TFE),

trifluoroethylene (VF3) homopolymers and copolymers,

copolymers, and in particular terpolymers, combining residues of chlorotrifluoroethylene (CTFE), tetrafluoroethylene (TFE), hexafluoropropylene (HFP) and/or ethylene units and optionally VF2 and/or VF3 units.

The fluoropolymer is preferably poly(vinylidene fluoride) (PVDF) homopolymer. The PVDF advantageously has a viscosity ranging from 100 Pa.s to 2000 Pa.s, the viscosity being measured at 230° C. and at a shear rate of 100 s⁻¹ using a capillary rheometer. Specifically, these PVDFs are particularly suitable for extrusion and injection. The PVDF preferably has a viscosity ranging from 300 Pa.s to 1200 Pa.s, the viscosity being measured at 230° C. and at a shear rate of 100 s⁻¹, using a capillary rheometer.

Thus, the PVDFs sold under the brand name Kynar® 710 or 720 are entirely suitable for this formulation.

As regards the electrically conductive product, these are all conductors of electricity. Examples which may be mentioned are metals and carbon-based products. Examples of carbon-based products which may be mentioned are graphite, carbon black, carbon nanotubes and carbon fibers. It would not constitute a departure from the context of the invention to use several electrically conductive components. The carbon-based products which may be used are described in Handbook of fillers 2^{nd} Edition published by Chem Tec Publishing 1999 page 62 § 2.1.22, page 92 § 2.1.33 and page 184 § 2.2.2.

The electrically conductive product is advantageously chosen from carbon blacks: the carbon blacks may be semiconductor blacks or conductor blacks, these carbon blacks having a small BET surface area. Among the carbon blacks which may be used, those from the company MMM Carbon are particularly satisfactory. The blacks which will be selected in particular are those whose nitrogen adsorption surface is less than 500 m²/g. These carbon blacks advantageously have a nitrogen adsorption surface of less than 100 m²/g. Among these different types, Ensaco® 250 is particularly suitable for sue.

As regards the triblock copolymer ABC, the block copolymer comprising at least three blocks A, B and C is such that block A is linked to block B and block B to block C by means of one or more covalent single bonds. In the case of several covalent bonds, between block A and block B and/or between block B and block C, there may be a single unit or a chain of units serving to join the blocks together. In the case of a single unit, this unit may originate from a so-called modifier monomer used in the synthesis of the triblock copolymer. In the case of a chain of units, this chain may be an oligomer resulting from a chain of monomer units of at least two different monomers in an alternating or random order. Such an oligomer may link block A to block B and the same oligomer or a different oligomer may link block B to block C.

Block A of a copolymer ABC is considered as being compatible with the fluoropolymer if the polymer A which is identical to this block (i.e. without blocks B or C) is compatible with this resin in molten form. Similarly, the blocks A and B are considered as being incompatible if the polymers A and B which are identical to these blocks are incompatible. In general, the expression “compatibility between two polymers” means the ability of one to dissolve in the other in molten form, or their total miscibility. In the opposite case, the polymers or blocks are said to be incompatible.

The lower the heat of blending of two polymers, the greater their compatibility. In certain cases, there is a favourable specific interaction between the monomers, which is reflected by a negative heat of blending for the corresponding polymers. In the context of the present invention, it is preferred to use compatible polymers whose heat of blending is negative or zero.

However, the heat of blending cannot be measured conventionally for all polymers, and thus the compatibility can only be determined indirectly, for example by viscoelastic analysis measurements in torsion and in oscillation, or alternatively by differential calorimetric analysis. For compatible polymers, 2 Tg values may be detected for the blend: at least one of the two Tg values is different from the Tg values of the pure compounds and is in the range of temperatures between the two Tg values of the pure compounds. The blend of two fully miscible polymers has only one Tg value.

Other experimental methods may be used to demonstrate the compatibility of polymers, such as turbidity measurements, light-scattering measurements or infrared measurements (L. A. Utracki, Polymer Alloys and Blends, pp 64-117).

Miscible or compatible polymers are listed in the literature: see, for example, J. Brandrup and E. H. Immergut : Polymer Handbook, 3rd Edition, Wiley & Sons 1979, New York 1989, pp. VI/348 to VI/364; O. Olabisi, L. M. Robeson and M. T. Shaw: Polymer Miscibility, Academic Press, New York 1979, pp. 215-276; L. A. Utracki: Polymer Alloys and Blends, Hanser Verlag, Munich 1989. The lists featured in these references are given for illustrative purposes and, needless to say, are not exhaustive.

The block A is advantageously chosen from alkyl (alkyl)acrylate homopolymers and copolymers and, for example, methyl methacrylate (MMA) and/or methyl or ethyl acrylate and/or those derived from vinyl acetate. The block A is advantageously poly(methyl methacrylate) (PMMA). This PMMA is preferably syndiotactic and its glass transition temperature Tg_{(A)}, measured by differential thermal analysis, is from +120° C. to +140° C.307

The Tg value of B is advantageously less than 0° C. and preferably less than −40° C.

The monomer used to synthesize the elastomeric block B may be a diene chosen from butadiene, isoprene, 2,3-dimethyl-1,3-butadiene, 1,3-pentadiene and 2-phenyl-1,3-butadiene. B is advantageously chosen from poly(dienes), in particular poly(butadiene), poly(isoprene) and random copolymers thereof, or alternatively from partially or totally hydrogenated poly(dienes). Among the polybutadienes that are advantageously used are those whose Tg value is lowest, for example poly(1,4-butadiene) whose Tg value (of about −90° C.) is lower than that of poly(1,2-butadiene) (of about0° C.). The blocks B may also be hydrogenated. This hydrogenation is carried out according to the usual techniques.

The monomer used to synthesize the elastomeric block B may also be an alkyl (meth)acrylate, and the following Tg values in parentheses are obtained according to the name of the acrylate: ethyl acrylate (−24° C.), butyl acrylate (−54° C.), 2-ethylhexyl acrylate (−85° C.), hydroxyethyl acrylate (−15° C.) and 2-ethylhexyl methacrylate (−10° C.). Butyl acrylate is advantageously used. The acrylates are different from those of the block A in order to comply with the condition of B and A being incompatible.

The blocks B preferably consist mainly of poly(1,4-butadiene).

The block C preferably has a glass transition temperature Tg_{(C)} or a melting point Tf_{(C)} which is greater than the Tg_{(B)} of the block B. This characteristic gives the possibility of the block C being in vitreous form or in a partially crystalline form and the block B in elastomeric form, for the same working temperature Tp.

According to the present invention, it is possible to select the nature of the blocks B so as to have a certain given Tg_{(B)} value and thus, at the working temperature Tp of the material or object formed from the blend, to have these B-block polymers in elastomeric or flexible form. On the other hand, since the C-block polymers may have a Tg_{(C)} value or a Tf which is greater than the Tg_{(B)} value, they may be in a relatively rigid vitreous form at the same working temperature.

As the blocks C are incompatible with the fluoropolymer, the blocks A and the blocks B, they form a discrete rigid phase inside the material, forming nanodomains included in the material and serving as anchors in the zone of one of the ends of each block B. The other end of each block B is linked to a block A which has high affinity with the fluoropolymer. This high affinity affords a second anchor in the zone of the second end of the block B.

The block C is advantageously chosen from homopolymers or copolymers of styrene or α-methylstyrene.

The triblocks which contain blocks derived from alkyl (alkyl)acrylate may be prepared in particular by anionic polymerization, for example according to the processes disclosed in patent applications EP-A-524 054 and EP-A-0 749 987.

The triblock copolymer ABC is preferably poly(methyl methacrylate-b-butadiene-b-styrene).

The triblock copolymer ABC may contain, as side products of its synthesis, a diblock copolymer B-C and possibly the homopolymer C. The triblock copolymer ABC may also contain, as side products of its synthesis, a diblock copolymer A-B and possibly the homopolymer A.

Specifically, the synthesis of a triblock copolymer is preferably carried out by successively combining block A with block B and then with block C or, conversely, block C with block B and then with block A, depending on the nature of the three blocks A, B and C, block A being by definition the block which is compatible with the fluoropolymer. The triblock copolymer ABC may also contain starburst or symmetrical linear block copolymers of the type ABA or CBC.

The total amount by weight of the synthesis side products, i.e. of these homopolymers A and C or block copolymers AB, BC, ABA and CBC is advantageously less than twice the amount of triblock ABC. This amount is preferably less than once and better still less than 0.5 times the amount of triblock copolymer ABC. More specifically, the side products are essentially the diblock copolymer BC, the amount of BC possibly being between 25 and 35 parts by weight per 75 to 65 parts, respectively, of ABC and is advantageously about 30 parts per 70 parts of ABC.

The number-average molecular mass (Mₙ) of the triblock copolymer, including the synthesis side products, is greater than or equal to 20 000 g.mol¹, and preferably between 50 000 and 200 000 g.mol⁻¹. The triblock copolymer ABC, including the side products, advantageously consists of:

from 20 to 93 parts and preferably from 30 to 70 parts by weight of blocks A,

from 5 to 68 parts and preferably from 10 to 40 parts by weight of blocks B,

from 2 to 65 parts and preferably from 5 to 40 parts by weight of blocks C.

The Applicant has found that, in the case of triblock copolymers, the side products derived from the synthesis, such as the diblock copolymers or the homopolymers, were not harmful to the mechanical properties of the blend.

The inner layer, i.e. the blend of the fluoropolymer, the electrically conductive product and the triblock copolymer ABC, possibly with the side products from the synthesis of the triblock copolymer, advantageously contains, by weight (the total being 100%):

65 to 97% of fluoropolymer,

0 to 25 % of electrically conductive product,

3 to 15% of triblock copolymer ABC.

As regards a conductive inner layer, its composition by weight may be, the total being 100%:

65 to 92% and advantageously 70 to 85% of fluoropolymer,

5 to 25% and advantageously 10 to 20% of electrically conductive product,

3 to 15% and advantageously 5 to 10% of triblock copolymer ABC.

As regards the binder layer, any product which allows adhesion between the inner layer and the layer of vulcanized elastomer is thus denoted. Examples which may be mentioned are blends of fluoropolymer, PMMA and optionally of acrylic elastomer of the core-shell type; the PMMA may comprise copolymerized (meth)acrylic acid. These binders are disclosed in patent U.S. Pat. No. 5,242,976. Mention may also be made of blends based on poly(meth)acrylates modified by imidation and optionally containing a fluoropolymer; they are disclosed in patents U.S. Pat. No. 5,939,492, U.S. Pat. No. 6,040,025, U.S. Pat. No. 5,795,939 and EP-A-0 726 926.

As regards the layer of vulcanized elastomer, the vulcanizable synthetic or natural elastomers which are suitable for carrying out the present invention are well known to those skilled in the art, in the definition of the present invention the term “elastomer” meaning that it may consist of blends of several elastomers.

These elastomers or blends of elastomers have a compression set at 100° C. of less than 50%, generally between 5% and 40% and preferably less than 30%.

Among these elastomers, mention may be made of natural rubber, polyisoprene with a high content of cis double bonds, a polymerized emulsion based on styrene/butadiene copolymer, a polybutadiene with a high content of cis double bonds obtained by nickel, cobalt, titanium or neodymium catalysis, a halogenated ethylene/propylene/diene terpolymer, a halogenated butyl rubber, a styrene/butadiene block copolymer, a styrene/isopropene block copolymer, halogenated products of the above polymers, an acrylonitrile/butadiene copolymer, an acrylic elastomer, a fluoroelastomer, chloroprene and epichlorohydrin rubbers.

If the tube of the invention comprises no binder layer, it is recommended that the elastomer should be chosen from functionalized elastomers, elastomers with acrylate units, halogenated elastomers and epichlorohydrin rubbers. As regards functionalized elastomers, this function is advantageously a carboxylic acid or carboxylic acid anhydride function. When the elastomers mentioned above comprise no carboxylic acid radicals or anhydride radicals of the said acids (which is the case for most of them), the said radicals will be provided by grafting, in a known manner, of the elastomers mentioned above or by blends of elastomers, for example with elastomers containing acrylic units such as acrylic acid. The abovementioned vulcanizable elastomers preferably comprise a weight content of carboxylic acid or dicarboxylic acid anhydride radicals of between 0.3% and 10% relative to the said elastomers.

Similarly, it is possible to blend elastomers which have no acrylate units or functions, which are not halogenated and which are not epichlorohydrin rubbers, with at least one elastomer chosen from functionalized elastomers, elastomers containing acrylate units, halogenated elastomers and epichlorohydrin rubbers.

Among the elastomers mentioned above which may be selected are those included in the following group: carboxylated nitrile elastomers, acrylic elastomers, carboxylated polybutadienes, grafted ethylene/propylene/diene terpolymers or blends of these polymers with the same elastomers but which are not grafted, such as nitrile rubbers, polybutadienes and ethylene/propylene/diene terpolymers, alone or as a mixture.

The vulcanizing systems that are suitable for the present invention are well known to those skilled in the art and, consequently, the invention is not limited to one particular type of system.

When the elastomer is based on unsaturated monomer (butadiene, isoprene, vinylidene-norbornene, etc.), four types of vulcanizing system may be mentioned:

Sulphur systems consisting of sulphur combined with the usual accelerators such as metal salts of dithiocarbamates (zinc, tellurium, etc. dimethyl dithiocarbamate), sulpheramides, etc.

The systems may also contain zinc oxide combined with stearic acid.

Sulphur donor systems in which most of the sulphur used for the bridges is derived from sulphur-containing molecules such as the organosulphur compounds mentioned above.

Phenolic resin systems consisting of difunctional formaldehyde-phenolic resins which may be halogenated, combined with accelerators such as stannous chloride or zinc oxide.

Peroxide systems. Any free-radical donor may be used (dicumyl peroxides, etc.) in combination with zinc oxide and stearic acid.

When the elastomer is acrylic (polybutyl acrylate with acid or epoxy functions or any other reactive function allowing crosslinking), the usual diamine-based crosslinking agents are used (orthotoluidyl guanidine, diphenylguanidine, etc.) or blocked diamines (hexamethylene diamine carbamate, etc.) are used.

The elastomeric compositions may be modified for certain particular properties (for example improvement of the mechanical properties) by adding fillers such as carbon black, silica, kaolin, alumina, clay, talc, chalk, etc. These fillers may be surface-treated with silanes, polyethylene glycols or any other coupling molecule. In general, the content of fillers in parts by weight is between 5 and 100 per 100 parts of elastomers.

In addition, the compositions may be made flexible with plasticizers such as mineral oils derived from petroleum, phthalic acid esters or sebacic acid esters, liquid polymer plasticizers such as polybutadiene of low mass which is optionally carboxylated, and other plasticizers that are well known to those skilled in the art.

The combinations of vulcanizing agent used are such that they should allow complete crosslinking of the elastomer with kinetics leading to good properties in terms of resistance to separation of the layer of elastomer and of the inner layer or of the binder layer.

The tubes of the invention may have an outside diameter of between 8 mm and 25 cm. The thickness of the inner layer may be between 15 μm and 200 μm, and that of the optional binder may be between 5 μm and 100 μm.

In a third embodiment of the invention, the fluoropolymer of the layer between the inner layer and the binder layer or between the inner layer and the layer of vulcanized elastomer, if there is no binder, is chosen from the fluoropolymers described for the inner layer. It is advantageously PVDF homopolymer or copolymer.

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all applications, patents and publications, cited above and below, and of corresponding French application 00/16.067, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

Furthermore, in the following claims the term “polymer” is intended to include homopolymers and copolymers, unless stated otherwise.

1. Tube having in its radial direction, from the inside outwards:
1) a so-called inner layer intended to come into contact with a circulating fluid, the said inner layer comprising (i) a fluoropolymer, (ii) optionally an electrically conductive product and (iii) a triblock copolymer ABC, the three blocks A, B, and C being linked together in this order, each block being either a homopolymer or a copolymer obtained from two or more monomers, the block A being linked to the block B and the block B to the block C by means of a covalent bond or an intermediate molecule linked to one of these blocks via a covalent bond and to the other block via another covalent bond, and such that:
block A is compatible with the fluoropolymer,
block B is incompatible with the fluoropolymer and is incompatible with block A,
block C is incompatible with the fluoropolymer, block A and block B,
2) optionally, a binder layer,
3) a layer of vulcanized elastomer.

2. Tube according to claim 1, in which the fluoropolymer of the inner layer is a PVDF homopolymer or copolymer.

3. Tube according to claim 1 or 2, in which the electrically conductive product of the inner layer is chosen from graphite, carbon black, carbon nanotubes and carbon fibers.

4. Tube according to claim 3, in which the electrically conductive product is carbon black with a nitrogen adsorption surface of less than 500 m²/g.

5. Tube according to claim 4, in which the surface area is less than 100 m²/g.

6. Tube according to any one of the preceding claims, in which the triblock copolymer ABC of the inner layer is poly (methyl methacrylate-b-butadiene-b-styrene).

7. Tube according to any one of the preceding claims, in which the number-average molecular mass (Mₙ) of the triblock copolymer ABC of the inner layer is greater than or equal to 20 000 g.mol⁻¹, and preferably between 50 000 and 20 000 g.mol⁻¹.

8. Tube according to any one of the preceding claims, in which the proportions are, by weight, in the inner layer:
65 to 97% of fluoropolymer,
0 to 25% of electrically conductive product,
3 to 15% of triblock coplymer ABC.

9. Tube according to claim 8, in which the proportions are, by weight:
65 to 92% of fluoropolymer,
5 to 25% of electrically conductive product,
3 to 15% of triblock copolymer ABC.

10. Tube according to any one of the preceding claims, in which the inner layer itself consists of two layers, one containing an electrically conductive product and the other containing no electrically conductive product.

11. Tube according to any one of the preceding claims, in which a layer of fluoropolymer is provided between the inner layer and the binder layer or between the inner layer and the layer of vulcanized elastomer, if there is no binder.
